(19) United States
(12) Patent Application Publication
(10) Pub. No.: US 2022/0224618 A1
(43) Pub. Date: Jul. 14, 2022

(54) TRANSCEIVER WITH INTEGRATED VISUAL INDICATOR FOR PORT LINK AND ACTIVITY

(71) Applicant: Dell Products L.P., Round Rock, TX (US)

(72) Inventors: Shree RATHINASAMY, Round Rock, TX (US); Maunish SHAH, Austin, TX (US)

(73) Assignee: Dell Products L.P., Round Rock, TX (US)

(21) Appl. No.: 17/147,269

(22) Filed: Jan. 12, 2021

(51) Int. Cl. H04L 12/26; H04L 12/24; H04L 7/00

(52) U.S. Cl. CPC H04L 43/0811; H04L 7/0075; H04L 41/22; H04L 43/0882

(57) ABSTRACT

An active device module may include an active device, a housing configured to house the active device, and a visual indicator integrated within the active device module and configured to visually indicate status information associated with a port of an information handling system to which the active device module is communicatively coupled.

### TECHNICAL FIELD

The present disclosure relates in general to information handling systems, and more particularly to systems and methods for providing a transceiver module with an integrated visual indicator for port link and activity.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system may have a network interface or other input/output (I/O) interface configured to receive an optical transceiver module (e.g., a small form-factor pluggable (SFP) transceiver or a quad small form-factor pluggable (QSFP) transceiver of any I/O speed). Such transceiver modules often plug into “cages” disposed on an I/O interface card, which often reside in the rear of the information handling system.

Existing network switches often have light-emitting diodes (LEDs) integrated into their front plates, wherein the LEDs provide an indication of link and activity for associated switch ports. With single network switches often having 32 ports or more, the associated LEDs may provide valuable information to network administrators. However, such integrated LEDs have some limitations.

For example, most of the switch ports may be coupled to servers and other equipment in a rack, and the large number of cables running from a switch may make it difficult to view an LED status of a particular port. Further, fiber optic ports may have optical transceivers plugged into the ports, making it harder to view an LED status of a particular port. In addition, cable management is used less frequently in test environments, which may render cable runs unsightly and LED status difficult to discern. Moreover, optical transceivers may have integrated tabs and cables may have push-pull tabs that also obstruct views of some switch LEDs.

### SUMMARY

In accordance with the teachings of the present disclosure, the disadvantages and problems associated with existing link status indicators for an information handling system may be reduced or eliminated.

In accordance with embodiments of the present disclosure, an active device module may include an active device, a housing configured to house the active device, and a visual indicator integrated within the active device module and configured to visually indicate status information associated with a port of an information handling system to which the active device module is communicatively coupled.

In accordance with these and other embodiments of the present disclosure, a method for fabricating an active device module may include housing an active device within a housing and integrating within the active device module a visual indicator configured to visually indicate status information associated with a port of an information handling system to which the active device module is communicatively coupled.

In accordance with these and other embodiments of the present disclosure, an information handling system may include a processor, a port communicatively coupled to the processor and configured to receive an active device module, and circuitry communicatively coupled to the processor and the port and configured to communicate status information associated with the port to the active device module received within the port such that a visual indicator integrated within active device module visually indicates status information associated with the port.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example information handling system, in accordance with embodiments of the present disclosure;

FIG. 2 illustrates an elevation view of a front panel of an example information handling system, in accordance with embodiments of the present disclosure;

FIG. 3A illustrates a plan view of a top of an example optical transceiver module, in accordance with embodiments of the present disclosure;

FIG. 3B illustrates an elevation view of a front of an example optical transceiver module, in accordance with embodiments of the present disclosure;

FIG. 4A illustrates a plan view of a top of an example information handling system with an example optical transceiver module inserted into an optical port of the information handling system, and a cable inserted into the optical transceiver module, in accordance with embodiments of the present disclosure;

FIG. 4B illustrates an elevation view of a front of an example information handling system with optical transceiver modules inserted into certain optical ports of the information handling system, and cables inserted into the optical transceiver modules, in accordance with embodiments of the present disclosure;

FIG. 5A illustrates a plan view of a top of an example information handling system with an example optical transceiver module inserted into an optical port of the information handling system, and a multi-breakout cable inserted into the optical transceiver module, in accordance with embodiments of the present disclosure;

FIG. 5B illustrates an elevation view of a front of an example information handling system with an optical transceiver module inserted into an optical port of the information handling system, and a multi-breakout cable inserted into the optical transceiver module, in accordance with embodiments of the present disclosure; and

FIG. 6 illustrates a block diagram of an example circuitry of an information handling system and optical transceiver modules that may implement one or both of top-side visual indicators and front-side visual indicators, in accordance with embodiments of the present disclosure.

### DETAILED DESCRIPTION

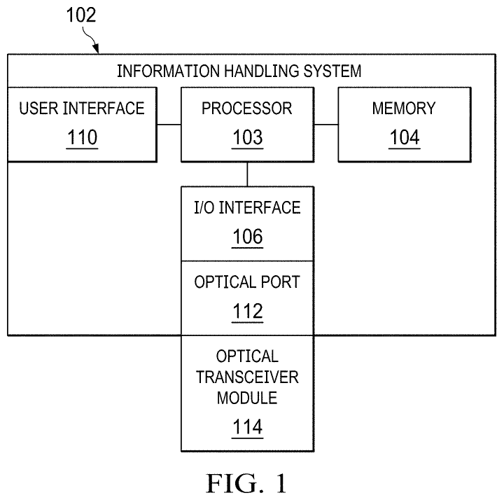

Preferred embodiments and their advantages are best understood by reference to FIGS. 1 through 6, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

For the purposes of this disclosure, circuit boards may broadly refer to printed circuit boards (PCBs), printed wiring boards (PWBs), printed wiring assemblies (PWAs) etched wiring boards, and/or any other board or similar physical structure operable to mechanically support and electrically couple electronic components (e.g., packaged integrated circuits, slot connectors, etc.). A circuit board may comprise a substrate of a plurality of conductive layers separated and supported by layers of insulating material laminated together, with conductive traces disposed on and/or in any of such conductive layers, with vias for coupling conductive traces of different layers together, and with pads for coupling electronic components (e.g., packaged integrated circuits, slot connectors, etc.) to conductive traces of the circuit board.

FIG. 1 illustrates a functional block diagram of selected components of an example information handling system 102, in accordance with embodiments of the present disclosure. In some embodiments, information handling system 102 may be a personal computer (e.g., a desktop computer or a portable computer). In other embodiments, information handling system 102 may comprise a storage server for archiving data. In yet other embodiments, information handling system 102 may comprise a server. In further embodiments, information handling system 102 may comprise a network switch.

As depicted in FIG. 1, information handling system 102 may include a processor 103, a memory 104 communicatively coupled to processor 103, an input/output interface 106 communicatively coupled to processor 103, a user interface 110 communicatively coupled to processor 103, and an optical port 112 communicatively coupled to I/O interface 106.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, and/or another component of information handling system 102.

Memory 104 may be communicatively coupled to processor 103 and may include any system, device, or apparatus configured to retain program instructions and/or data for a period of time (e.g., computer-readable media). Memory 104 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to its associated information handling system 102 is turned off.

I/O interface 106 may comprise any suitable system, apparatus, or device operable to serve as an interface between information handling system 102 and one or more other external devices. For example, in some embodiments, I/O interface 106 may comprise a network interface configured to serve as an interface between information handling system 102 and information handling systems via a network, in which case I/O interface 106 may comprise a network interface card, or “NIC.”

User interface 110 may comprise any instrumentality or aggregation of instrumentalities by which a user may interact with information handling system 102. For example, user interface 110 may permit a user to input data and/or instructions into information handling system 102, and/or otherwise manipulate information handling system 102 and its associated components. User interface 110 may also permit information handling system 102 to communicate data to a user, e.g., by way of a display device.

Optical port 112 may comprise an electrical connector in the form of any suitable combination of a jack, a socket, and/or “cage” for receiving a corresponding connector of an optical transceiver module 114.

Optical transceiver module 114 may include any system, device, or apparatus that houses and includes an optical transceiver configured to convert an incoming optical signal into an equivalent electrical signal, and communicate such equivalent electrical signal to I/O interface 106, and also configured to receive an electrical signal from I/O interface 106, convert such electrical signal into an equivalent optical signal, and communicate such optical signal as an outgoing optical signal (e.g., via an optical cable, which may be integral to the same assembly as optical transceiver module 114). Optical transceiver module 114 may include an SFP transceiver, a QSFP transceiver, or any other suitable form factor.

Although FIG. 1 depicts information handling system 102 having only a single optical port 112 and single optical transceiver module 114, in many embodiments, especially in those in which information handling system 102 is a network switch, information handling system 102 may have a plurality of optical ports 112, each optical port 112 configured to receive an optical transceiver module 114.

In addition to processor 103, memory 104, I/O interface 106, user interface 110, optical port 112, and optical transceiver module 114, information handling system 102 may include one or more other information handling resources. Such an information handling resource may include any component system, device or apparatus of an information handling system, including without limitation, a processor, bus, memory, I/O device and/or interface, storage resource (e.g., hard disk drives), network interface, electro-mechanical device (e.g., fan), display, power supply, and/or any portion thereof. An information handling resource may comprise any suitable package or form factor, including without limitation an integrated circuit package or a printed circuit board having mounted thereon one or more integrated circuits.

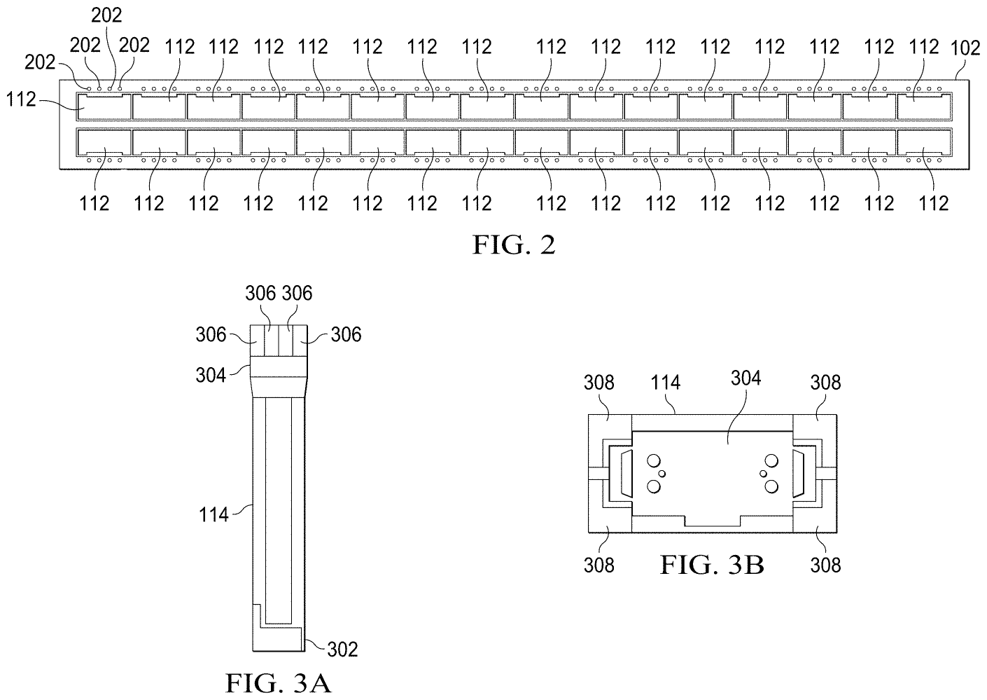

FIG. 2 illustrates an elevation view of a front panel of an example information handling system 102, in accordance with embodiments of the present disclosure. In particular, FIG. 2 illustrates a front panel of an information handling system 102 implemented as a network switch. As shown in FIG. 2, information handling system 102 may have a plurality of optical ports 112, and one or more visual indicators 202 (e.g., four visual indicators 202 in the embodiments represented by FIG. 2) associated with each optical port 112. Each visual indicator 202 may comprise any system, device, or apparatus configured to emit light or other visual stimulus to indicate to a person a status (e.g., link connection status, link connection speed, etc.) associated with its associated optical port 112. For example, in some embodiments, each visual indicator 202 may comprise a light-emitted diode (LED). In some embodiments, each visual indicator 202 may have two possible visual states (e.g., on or off indicating whether a link associated with an optical port 112 is active or inactive). In other embodiments, each visual indicator 202 may have three or more possible visual states (e.g., on or off indicating whether a link associated with an optical port 112 is active or inactive, and different colors to indicate connection speed).

FIG. 3A illustrates a plan view of a top of an example optical transceiver module 114, in accordance with embodiments of the present disclosure. FIG. 3B illustrates an elevation view of a front of an example optical transceiver module 114, in accordance with embodiments of the present disclosure. As shown in FIGS. 3A and 3B, an optical transceiver module 114 may include a port connector 302 for coupling to an optical port 112 and a cable connector 304 for coupling to a cable (e.g., a fiber optic cable), such that optical transceiver module 114 serves as an interface between an optical cable and an optical port 112.

As shown in FIG. 3A, an optical transceiver module 114 may include one or more integrated top-side visual indicators 306. Each top-side visual indicator 306 may comprise any system, device, or apparatus configured to emit light or other visual stimulus to indicate to a person a status (e.g., link connection status, link connection speed, etc.) associated with optical transceiver module 114.

Similarly, as shown in FIG. 3B, an optical transceiver module 114 may include one or more integrated front-side visual indicators 308. Each front-side visual indicator 308 may comprise any system, device, or apparatus configured to emit light or other visual stimulus to indicate to a person a status (e.g., link connection status, link connection speed, etc.) associated with optical transceiver module 114.

Although FIGS. 3A and 3B contemplate an optical transceiver module 114 having both one or more integrated top-side visual indicators 306 and one or more integrated front-side visual indicators 308, in some embodiments, an optical transceiver module 114 may include only one or more integrated top-side visual indicators 306 (and no integrated front-side visual indicators 308) or may include only one or more integrated front-side visual indicators 308 (and no integrated top-side visual indicators 306).

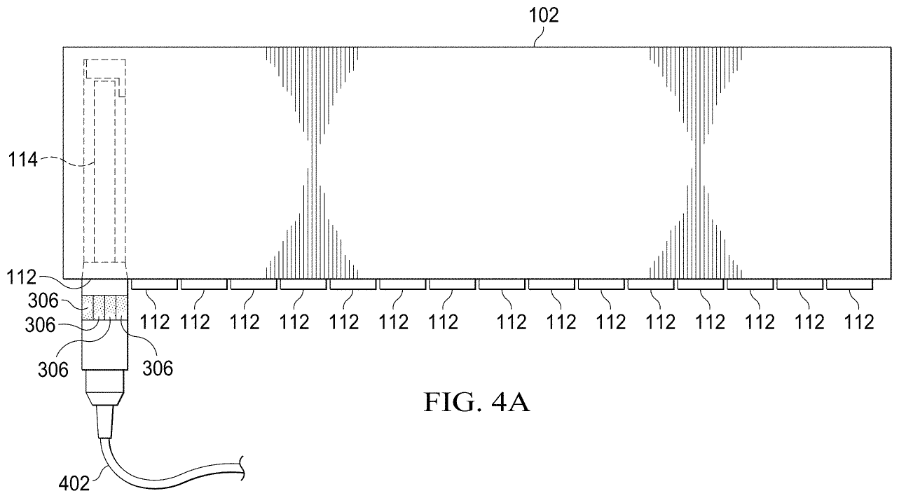

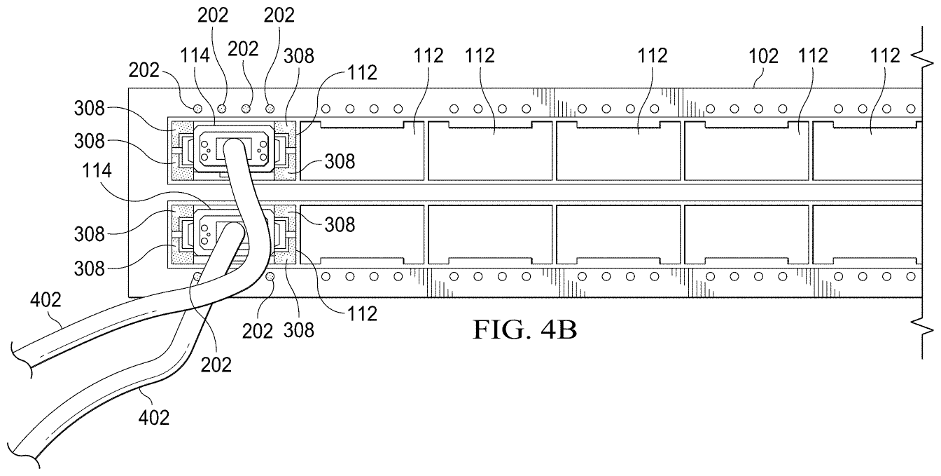

FIG. 4A illustrates a plan view of a top of an information handling system 102 with an example optical transceiver module 114 inserted into an optical port 112 thereof, and a cable 402 inserted into the optical transceiver module 114, in accordance with embodiments of the present disclosure. FIG. 4B illustrates an elevation view of a front of an information handling system 102 with optical transceiver modules 114 inserted into certain optical ports 112 thereof, and cables 402 inserted into the optical transceiver modules 114, in accordance with embodiments of the present disclosure.

As shown in FIG. 4A, when an optical transceiver module 114 is inserted into an optical port 112 and a cable 402 is coupled to the optical transceiver module 114, top-side visual indicators 306 of such optical transceiver module 114 may replicate visual indications given by visual indicators 202 of such optical port 112. Similarly, as shown in FIG. 4B, when an optical transceiver module 114 is inserted into an optical port 112 and a cable 402 is coupled to the optical transceiver module 114, front-side visual indicators 308 of such optical transceiver module 114 may replicate visual indications given by visual indicators 202 of such optical port 112. Notably, as seen from FIG. 4B, cables 402 may visually block one or more visual indicators 202. However, top-side visual indicators 306 and front-side visual indicators 308 may provide additional visual indication of link and activity status to that of visual indicators 202, thus potentially overcoming one or more disadvantages cited in the Background section of this application.

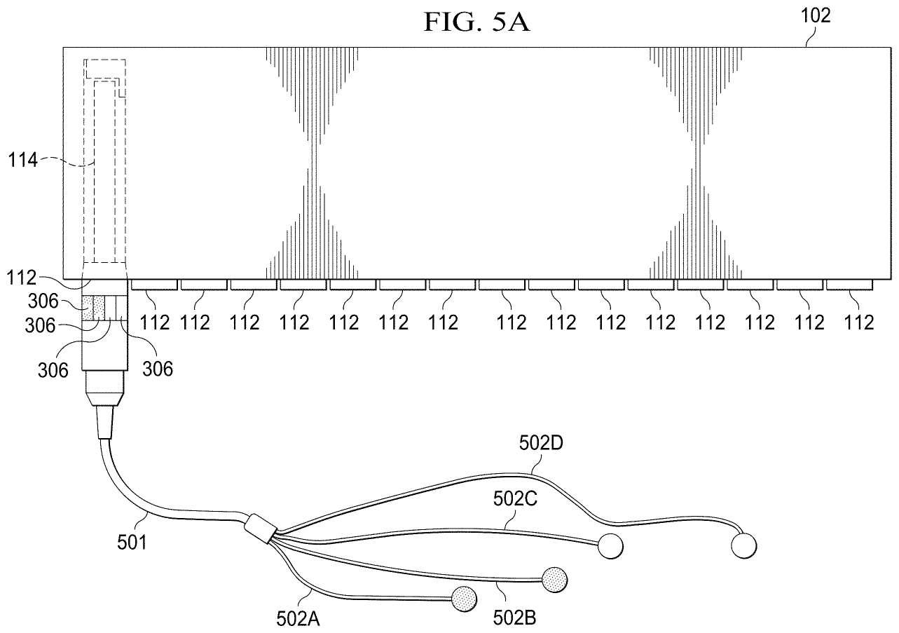

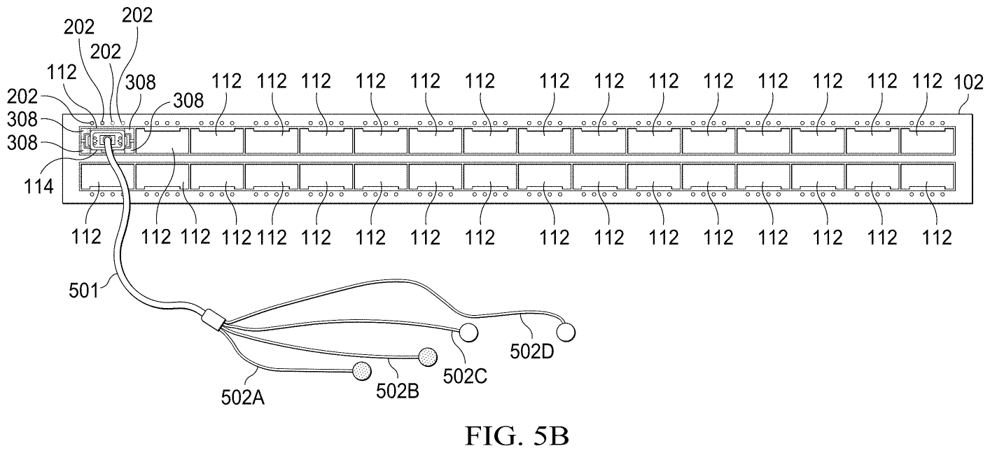

FIG. 5A illustrates a plan view of a top of an information handling system 102 with an example optical transceiver module 114 inserted into an optical port 112 thereof, and a multi-breakout cable 501 inserted into the optical transceiver module 114, in accordance with embodiments of the present disclosure. FIG. 5B illustrates an elevation view of a front of an information handling system 102 with an optical transceiver module 114 inserted into an optical port 112 thereof, and a multi-breakout cable 501 inserted into the optical transceiver module 114, in accordance with embodiments of the present disclosure.

As shown in FIG. 5A, when an optical transceiver module 114 is inserted into an optical port 112 and a multi-breakout cable 501 having breakouts 502A, 502B, 502C, and 502D is coupled to the optical transceiver module 114, top-side visual indicators 306 of such optical transceiver module 114 may replicate visual indications associated with the various breakouts 502 given by visual indicators 202 of such optical port 112. For example, as shown in FIG. 5A, if only breakouts 502A and 502B are connected to another device, the visual indicators 202 and top-side visual indicators 306 associated with breakout ports of optical port 112 in communication with breakouts 502A and 502B may provide visual indication of an active link (e.g., LED turned on), while those visual indicators 202 and top-side visual indicators 306 associated with breakout ports of optical port 112 in communication with breakouts 502C and 502D may provide visual indication of an inactive link (e.g., LED turned off).

Similarly, as shown in FIG. 5B, when an optical transceiver module 114 is inserted into an optical port 112 and a multi-breakout cable 501 having breakouts 502A, 502B, 502C, and 502D is coupled to the optical transceiver module 114, front-side visual indicators 308 of such optical transceiver module 114 may replicate visual indications associated with the various breakouts 502 given by visual indicators 202 of such optical port 112. For example, as shown in FIG. 5B, if only breakouts 502A and 502B are connected to another device, the visual indicators 202 and front-side visual indicators 308 associated with breakout ports of optical port 112 in communication with breakouts 502A and 502B may provide visual indication of an active link (e.g., LED turned on), while those visual indicators 202 and front-side visual indicators 308 associated with breakout ports of optical port 112 in communication with breakouts 502C and 502D may provide visual indication of an inactive link (e.g., LED turned off).

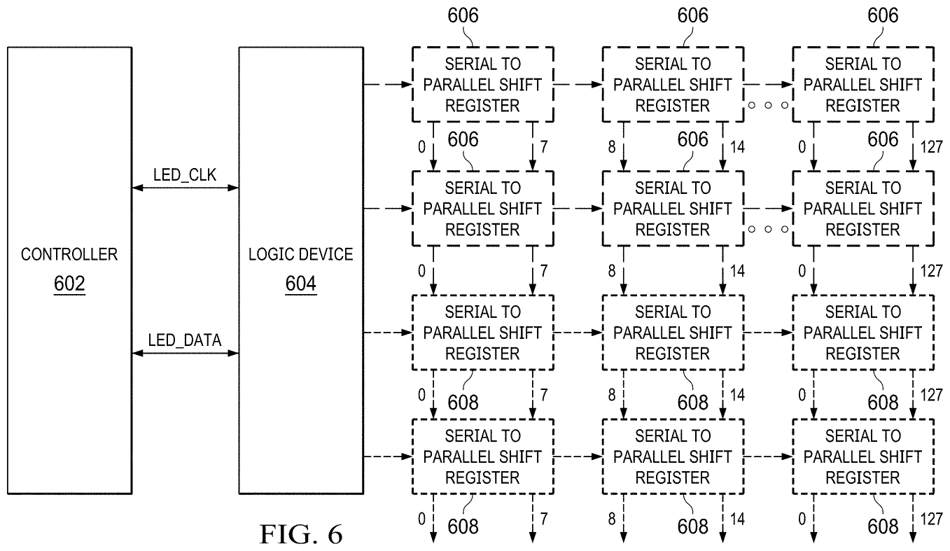

FIG. 6 illustrates a block diagram of an example circuitry of information handling system 102 and optical transceiver modules 114 that may implement one or both of top-side visual indicators 306 and front-side visual indicators 308. As shown in FIG. 6, a controller 602 (e.g., application-specific integrated circuit) in connection with a logic device 604 (e.g., a complex-programmable logic device) of information handling system 102 may control one or more shift registers 606 that carry signals for illuminating visual indicators 202, and may replicate such signals to shift registers 608 integrated within optical transceiver modules 114 that carry signals for illuminating top-side visual indicators 306 and/or front-side visual indicators 308.

Although the foregoing contemplates the presence of visual indicators (e.g., top-side visual indicators 306 and/or front-side visual indicators 308) on an optical transceiver module 114 in order to replicate a port visual indicator associated with an optical port 112 of an information handling system 102 to which optical transceiver module 114 is communicatively coupled, in some embodiments an information handling system 102 may not include its own visual indicators, and thus, in such embodiments, visual indicators on the optical transceiver module 114 may alone visually indicates status information associated with the port.

Although the foregoing contemplates the use of the methods and systems disclosed herein in direct attached copper and active optical cable solutions, embodiments disclosed herein may be extended for use in unique form factors and constraints of pluggable optical transceivers.

Although the foregoing contemplates the use of the methods and systems disclosed herein with respect to cable-attached optical transceiver modules, the heat transfer techniques disclosed herein may be applied generally to any active device module having a heat-generating device coupled to a cable, including without limitation transceiver modules other than optical transceiver modules.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An active device module, comprising:
an active device;
a housing configured to house the active device; and
a visual indicator integrated within the active device module and configured to visually indicate status information associated with a port of an information handling system to which the active device module is communicatively coupled.

2. The active device module of claim 1, wherein the visual indicator is further configured to replicate a port visual indicator associated with the port of an information handling system to which the active device module is communicatively coupled, such that the visual indicator visually indicates the status information associated with the port which is also visually indicated by the port visual indicator.

3. The active device module of claim 2, wherein the visual indicator is located on a top side of the active device module such that when the active device module is received in the port, the visual indicator emits visual indication in a first direction substantially perpendicular to a second direction in which the port visual indicator emits visual indication.

4. The active device module of claim 2, wherein the visual indicator is located on a front side of the active device module such that when the active device module is received in the port, the visual indicator emits visual indication in a same direction in which the port visual indicator emits visual indication.

5. The active device module of claim 1, wherein the active device is an optical transceiver.

6. The active device module of claim 1, wherein the visual indicator is a light-emitting diode.

7. The active device module of claim 1, wherein the status information comprises at least one of a link status and a connection speed associated with the port.

8. A method for fabricating an active device module comprising:
housing an active device within a housing; and
integrating within the active device module a visual indicator configured to visually indicate status information associated with a port of an information handling system to which the active device module is communicatively coupled.

9. The method of claim 1, wherein the visual indicator is further configured to replicate a port visual indicator associated with the port of an information handling system to which the active device module is communicatively coupled, such that the visual indicator visually indicates the status information associated with the port which is also visually indicated by the port visual indicator.

10. The method of claim 9, wherein integrating the visual indicator within the active device module comprises locating the visual indicator on a top side of the active device module such that when the active device module is received in the port, the visual indicator emits visual indication in a first direction substantially perpendicular to a second direction in which the port visual indicator emits visual indication.

11. The method of claim 9, wherein integrating the visual indicator within the active device module comprises locating the visual indicator on a front side of the active device module such that when the active device module is received in the port, the visual indicator emits visual indication in a same direction in which the port visual indicator emits visual indication.

12. The method of claim 8, wherein the active device is an optical transceiver.

13. The method of claim 8, wherein the visual indicator is a light-emitting diode.

14. The method of claim 8, wherein the status information comprises at least one of a link status and a connection speed associated with the port.

15. An information handling system, comprising:
a processor;
a port communicatively coupled to the processor and configured to receive an active device module; and
circuitry communicatively coupled to the processor and the port and configured to communicate status information associated with the port to the active device module received within the port such that a visual indicator integrated within active device module visually indicates status information associated with the port.

16. The information handling system of claim 15, wherein the circuitry is further configured to replicate a port visual indicator associated with the port to the visual indicator such that the visual indicator visually indicates status information associated with the port which is also visually indicated by the port visual indicator.

17. The information handling system of claim 16, wherein the visual indicator is located on a top side of the active device module such that when the active device module is received in the port, the visual indicator emits visual indication in a first direction substantially perpendicular to a second direction in which the port visual indicator emits visual indication.

18. The information handling system of claim 16, wherein the visual indicator is located on a front side of the active device module such that when the active device module is received in the port, the visual indicator emits visual indication in a same direction in which the port visual indicator emits visual indication.

19. The information handling system of claim 15, wherein the active device module comprises an optical transceiver.

20. The information handling system of claim 15, wherein the visual indicator is a light-emitting diode.

21. The information handling system of claim 15, wherein the status information comprises at least one of a link status and a connection speed associated with the port.
